(19) United States
(12) Patent Application Publication
(10) Pub. No.: US 2009/0140598 A1
(43) Pub. Date: Jun. 4, 2009

(54) Rotor construction in an electric motor

(76) Inventors: Arno Schieweck, Schwaig (DE); Juergen Strueber, Nuernberg (DE)

Correspondence Address: JACOBSON HOLMAN PLLC, 400 SEVENTH STREET N.W., SUITE 600, WASHINGTON, DC, 20004, US

(21) Appl. No.: 12/292,315

(22) Filed: Nov. 17, 2008

(30) Foreign Application Priority Data
Nov. 21, 2007 (DE) 102007055542.5

(51) Int. Cl. H02K 1/28

(52) U.S. Cl. 310/217

(57) ABSTRACT

A rotor of an electric motor with a cylindrical shaft and a magnetically conducting laminated core, the laminated core having a central shaft duct. The laminated core can be fastened reliably and permanently to the rotor shaft, without significantly increasing manufacturing costs. This task is accomplished by adhesively connecting the shaft to the laminated core in the area of its inside contour as by welding.

### CROSS-REFERENCE TO RELATED APPLICATIONS

(Not applicable)

### STATEMENT REGARDING FEDERALLY SPONSORED RESEARCH OR DEVELOPMENT

(Not applicable)

### BACKGROUND OF THE INVENTION

(1) Field of the Invention

The invention concerns a rotor construction in an electric motor, in general, and to a rotor with a cylindrical shaft and a motor with a magnetically conducting laminated core with a central shaft duct, in particular.

(2) Description of Related Art

A variety of fastening options for mounting a laminated core on a motor shaft are known. In the prior art, smooth shafts are often machined and provided with notches and burrs or knurling, in order to partially increase the shaft diameter. This shaft machining requires additional manufacturing steps, without being able to guarantee adequate strength of the force-fit connection when the connected shaft and laminated core are subjected to a high load.

### BRIEF SUMMARY OF THE INVENTION

An object of the invention is therefore to devise a rotor for an electric motor, in which a laminated rotor core can be fastened reliably and permanently to a rotor shaft, without significantly increasing manufacturing costs. This object is solved according to the invention in that the rotor shaft is adhesively bonded (for example by welding) to the laminated core in the area of its inside contour. This type of joining is sufficiently strong and permanent.

Modifications contemplated by the invention include shaping the inside contour of the central shaft duct, so that the laminated core only lies partially against the shaft. Proper centering of the laminated core is achieved on this account and the bonded connection can be produced under favorable conditions.

One possibility for the shape of the inside contour is a polygon. Depending on the requirements for mechanical strength and accuracy of the joint, for example an inside square or inside triangle can be used. This shape can be punched by a conventional punch-out process at the same time that the individual layers are punched from sheets for eventual stacking to form the laminated core and therefore requires no additional expense.

It is important here that the diameter of an inscribed circle in the shaft duct be slightly smaller than the outside diameter of the shaft before preassembly of the shaft and laminated core. Because of this relationship between the two diameters, before production of the bonded connection, the laminated core is fixed on the shaft in correct position, so that assembly errors are unlikely. The described connection is suitable both for shafts made of hardened steel material and for shafts made of unhardened steel material.

The production of the connection between the laminated core and shaft by electrical resistance welding is particularly advantageous. Because this can be conducted with a simple device, proper adhesive bonding is ensured.

The following process steps are proposed for production of the bonded connection:

Punch-out from a sheet the core layers, each layers having a shaft cutout,
Laminate the core layers to each other to form the laminated core with an elongated shaft duct,
Introduce the shaft into the elongated shaft duct,
Apply electrodes to the shaft and the laminated core,
Weld the shaft to the laminated core by a brief application of a welding voltage (voltage surge) to the electrodes.

The result of this process is that the laminated core is adhesively bonded to the shaft in one working step.

Several electrodes are expediently mounted on the periphery of the laminated core and placed together at a first voltage potential, while another voltage potential is applied to the shaft. To reduce the welding current, the welding process can also be conducted in sections, so that the welding current is applied in succession to individual core layers or partial laminated cores. It can also be sufficient to merely weld the laminated core on an axially limited initial and end section to the shaft, especially when the laminated core is in the form of a compact unit.

### BRIEF DESCRIPTION OF THE DRAWINGS

Practical examples of the invention are further explained below with reference to the drawings, which are not drawn to scale:

FIG. 1 is a schematic diagram of a rotor embodying the present invention in a welding device.

FIG. 2 is a schematic diagram through the center of the laminated core of FIG. 1.

FIG. 3 is a schematic view of the laminated core of FIG. 1 to explain the inscribed circle and show a triangular inside contour of the laminated core.

FIG. 4 is a flow diagram of the method for making the inventive rotor.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

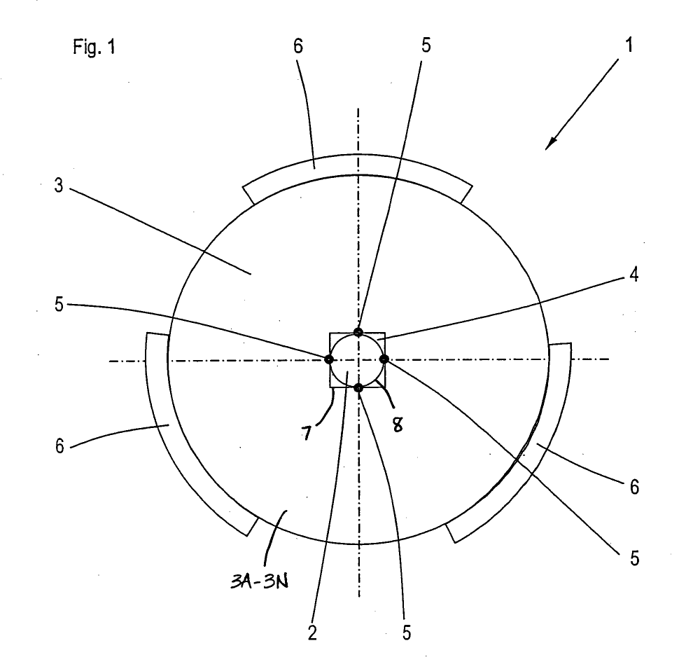

FIG. 1 is a schematic diagram of a rotor 1 in a welding device. To simplify matters, the welding device is shown with only three welding electrodes 6. In operation, the welding electrodes are applied to a laminated core 3 of the rotor 1.

The laminated core is made up of a number of layers 3A-3N stacked one upon the other and laminated together is a conventional manner. In FIG. 1, the laminated core is viewed from above with the laminated core extending into the paper. The laminated core has a central cut out that extends through the full depth of the laminated layers that make up the core. This central cutout is referred to as a shaft duct 4 that is shaped to receive a shaft 2. As shown in FIG. 1, the cross-section of the shaft duct 4 has a contour surface 7 that defines a square in the depicted example, so that in the geometrically ideal form, four contact lines are produced between the shaft 2 and the laminated core 3. These contact lines have only a limited width, so that a welding current applied to the electrodes 6, on the one hand, and the shaft, on the other, is strongly concentrated and sufficient heat is produced to weld the joining partners. The welding sites 5 are therefore generated. It is also contemplated that the polygonal cross section can also assume of forms such as a triangle.

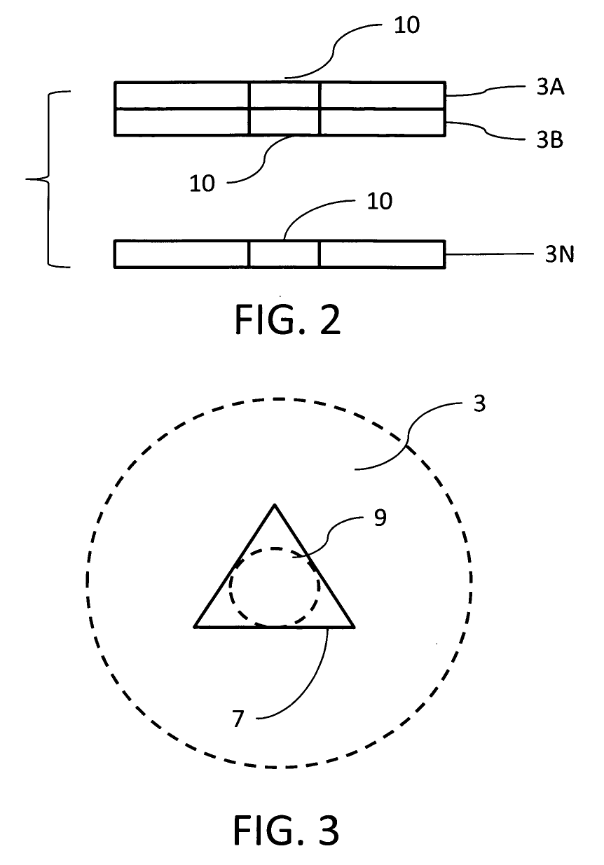

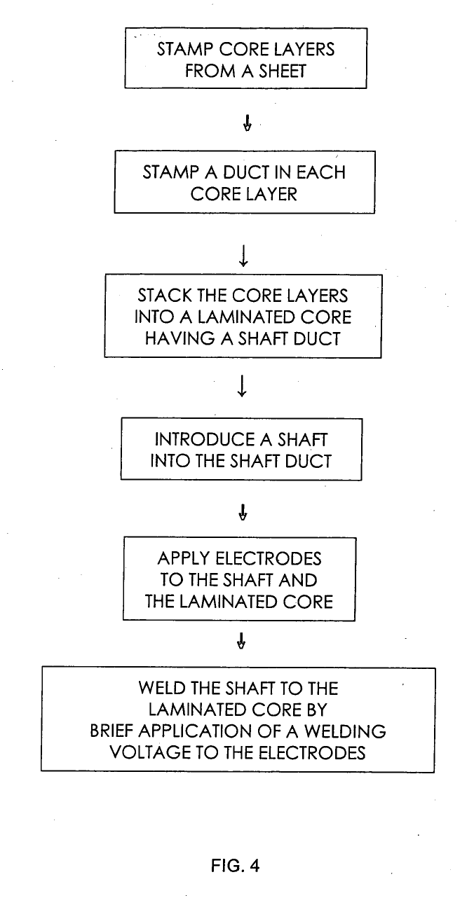

With reference to FIGS. 1-4, a method for fastening the laminated core to the cylindrical shaft of the electric motor is shown and described. According to the method, core layers 3A, 3B to 3N are stamped from a sheet or sheets. At the same time, shaft cutouts are created in each of the core layers. The core layers are then stacked and laminated together to define a laminated core 3 that has a shaft duct 2 defined by aligning the shaft cutouts 10.

The shaft is then inserted into to shaft duct and positioned in proper position to form a rotor with the laminated core. Electrodes 6 are then applied to the shaft and the laminated core. After the electrodes 6 are in place, the shaft 2 is welded at welding sites 5 to the laminated core 3 by brief application of a welding voltage to the electrodes.

It is to be understood that the present invention is not limited to the illustrated embodiments described herein. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE NUMERALS

1 Rotor
2 Shaft
3 Laminated core
4 Shaft duct
5 Welding site
6 Electrodes
7 Inside contour of the laminated core
8 Surface diameter of shaft
9 Inscribed circle
10 Shaft cutout

What is claimed is:

1. A rotor (1) of an electric motor, the rotor comprising:
a cylindrical shaft (2);
a magnetically conducting laminated core (3) having a central shaft duct (4); and
means for bonding the shaft (2) to the laminated core (3) in the areas of contact between the shaft and the inside contour (7) of the laminated core.

2. The rotor according to claim 1, wherein the inside contour (7) of the central shaft duct (4) is shaped, so that the inside contour of the laminated core (3) only lies in partial contact with the shaft (2).

3. The rotor according to claim 1, wherein the inside contour (7) is polygonal.

4. The rotor according to claim 1, wherein the inside contour (7) has the shape of a square.

5. The rotor according to claim 1, wherein the inside contour (7) has the shape of a triangle.

6. The rotor according to claim 1, wherein the diameter of an inscribed circle (9) defined by the inside contour (7) of the shaft duct (4) of the laminated core before receiving the shaft is slightly less than the surface diameter (8) of the shaft (2).

7. The rotor according to claim 1, wherein the shaft (2) consists of a hardened steel material.

8. The rotor according to claim 1, wherein the shaft (2) consists of an unhardened steel material.

9. A method for fastening a laminated core to a cylindrical shaft of an electric motor according to claim 1, the method comprising the steps of bonding the laminated core to the shaft by electrical resistance welding.

10. A method for fastening a laminated core to a cylindrical shaft of an electric motor, the method comprising the steps of:
stamping core layers from a sheet;
creating a shaft cutout in each of the core layers;
stacking the core layers into a laminated core and defining a shaft duct by aligning the shaft cutouts;
introducing the shaft into the shaft duct;
applying electrodes to the shaft and the laminated core;
welding the shaft to the laminated core by brief application of a welding voltage to the electrodes.

11. The method according to claim 10, wherein during welding, the method further comprises:
applying several electrodes on the periphery of the laminated core (3),
connecting the several electrodes electrically to a first voltage potential; and
connecting the shaft (2) to another electrode that is electrically connected to a second voltage potential.

12. The method according to claim 9, wherein the welding step is conducted in sections, so that a welding current is applied in succession to individual core layers.

13. The method according to claim 9, wherein the welding current is pulsed.

14. The method according to claim 9, wherein the welding current is continuously applied.

15. The method according to claim 9, wherein during welding the welding electrodes are moved along the laminated core.

16. The method according to claim 9, wherein the laminated core has first and second ends and the welding step further comprises welding the laminated core (3) to the shaft at the first and second ends.
